(19) United States
(12) Patent Application Publication
(10) Pub. No.: US 2013/0284674 A1
(43) Pub. Date: Oct. 31, 2013

(54) ORGANIC COMPOUND ADSORBING MATERIAL AND PROCESS FOR MAKING THE SAME

(71) Applicant: Mark Moskovitz, Atlanta, GA (US)

(72) Inventor: Mark Moskovitz, Atlanta, GA (US)

(21) Appl. No.: 13/810,418

(22) PCT Filed: Jul. 22, 2011
(86) PCT No.: PCT/US11/45034

§ 371 Date: Jun. 28, 2013

Related U.S. Application Data
(60) Provisional application No. 61/366,765, filed on Jul. 22, 2010.

(51) Int. Cl. B01J 20/22; B05D 3/10; B05D 3/02; C02F 1/28; B01J 20/32

(52) U.S. Cl. CPC B01J 20/22; C02F 1/28; B01J 20/3236; B05D 3/0254; B05D 3/108
USPC 210/675; 210/691; 502/401; 252/181; 427/372.2; 427/343

(57) ABSTRACT

Provided herein is a material for monitoring and/or treating the presence of contaminant organic compounds in water. The material is a matrix of fibers impregnated with one or more metal oxides.

### CROSS-RELATED APPLICATIONS

This claims the benefit of provisional application 61/336,765, filed on Jul. 22, 2010, which is incorporated by reference in its entirety.

### FIELD OF THE INVENTION

The present invention relates to an adsorbing material that is capable of removing oil from a liquid.

### BACKGROUND

The continuing occurrence of oil spillage into marine and inland waterways has brought to the fore the need for implementation of new and effective ways to deal with oil spill incidents. For example, the recent oil spill in the Gulf of Mexico, which flowed for three months in 2010, affected greater than 4,900 sq. km of surface waters, the water column, the benthos, shorelines, beaches and salt marshes, and bays in the northeastern Gulf of Mexico, and theses effects are expected to continue for some time into the future. Furthermore, there has been controversy regarding the quality of the water in the northeastern Gulf of Mexico with respect to contaminants derived from the crude oil spill. Diminished water quality in this region can represent a threat to human health, sea life, and seafood safety, each of which impact key industries for states of the Gulf coast.

Oil-containment systems often utilize booms to surrounds the oil spill until the oil can be collected. Boom systems are often not designed to absorb substantial amounts of oil, but rather are generally used to retrieve a sheen or a small oil spill or to prevent the spill from expanding or reaching a protected area such as a shoreline until it can be collected by mechanical means, typically utilizing skimmers or oil-recovery boats. A delayed response to a spill will often allow lighter fraction of the oil, such as volatile organic compounds, to be released into the atmosphere, resulting in hydrocarbon air pollution. The oil may also undergo aging and emulsification, which can cause the oil to sink, making cleanup of the spill to become much more difficult, increase the environmental impact, and raise the financial cost of the cleanup.

Accordingly, there is a need for an oil-recovery system that is capable of quickly containing the extent of the oil spill and, at the same time, is capable of adsorbing a substantial amount of the oil.

### SUMMARY OF THE INVENTION

Provided herein is a material that is capable of adsorbing organic compounds, such as oil. As such, this material is useful for the recovery of oil from sites of spillage and leakage. The material comprises a fiber and a metal oxide. The material may be arranged in a matrix. The fiber may be polyester, nylon, cotton or a combination thereof. The fiber may be in a form that is knitted, woven and/or spun-bonded. The matrix may be a loose packed textile, a woven textile, a nonwoven textile or a needle punched textile. The nonwoven textile may be felted. The needle punched textile may be a nonwoven textile. The fiber may be a blend of two or more fibers. The cotton may be grown in Georgia, United States of America. The cotton may be natural, bleached, or a blend thereof. The metal oxide may be alumina, silicon dioxide, carbon, titanium, zirconium, copper (I), copper (II), sodium, magnesium, lithium, silver, iron (II), iron (III), chromium (VI), titanium (IV), zinc, or a combination thereof. The metal oxide may have a transformation state. For example, alumina may have a transformation state of gamma, eta, rho, chi, chi-rho, or theta. If the metal oxide is carbon, the carbon may be activated carbon. The material may contain the metal oxide on one or more sides. The material may contain the metal oxide on two sides. The metal oxide may saturate the material.

Also provided herein are methods of making the material that is capable of adsorbing organic compounds. The method comprises contacting a fiber with a metal oxide to form a metal oxide fiber and arranging the metal oxide fiber into a matrix. The metal oxide fiber matrix may then be dried to form the organic compound adsorbing material. The act of contacting the fiber with a metal oxide may be accomplished by spray coating the metal oxide onto the fiber. The metal oxide fiber matrix may be dried via fluid bed drying, air drying, single pass oven drying, double pass oven drying, or three pass oven drying. The metal oxide fiber matrix may be acid treated before drying. The material may be arranged in a matrix. The fiber may be polyester, nylon, cotton or a combination thereof. The fiber may be in a form that is knitted, woven and/or spun-bonded. The matrix may be a loose packed textile, a woven textile, a nonwoven textile or a needle punched textile. The nonwoven textile may be felted. The needle punched textile may be a nonwoven textile. The fiber may be a blend of two or more fibers. The cotton may be grown in Georgia, United States of America. The cotton may be natural, bleached, or a blend thereof. The metal oxide may be alumina, silicon dioxide, carbon, titanium, zirconium, copper (I), copper (II), sodium, magnesium, lithium, silver, iron (II), iron (III), chromium (VI), titanium (IV), zinc, or a combination thereof. The metal oxide may have a transformation state. For example, alumina may have a transformation state of gamma, eta, rho, chi, chi-rho, or theta. If the metal oxide is carbon, the carbon may be activated carbon. The material may contain the metal oxide on one or more sides. The material may contain the metal oxide on two sides. The metal oxide may saturate the material.

Another method of making the material that is capable of adsorbing organic compounds comprises contacting a matrix of fiber with a metal oxide to form a metal oxide fiber matrix and then drying the metal oxide fiber matrix to form the organic compound adsorbing material. The act of contacting the fiber with a metal oxide may be accomplished by spray coating the metal oxide onto the fiber. The metal oxide fiber matrix may be dried via fluid bed drying, air drying, single pass oven drying, double pass oven drying, or three pass oven drying. The metal oxide fiber matrix may be acid treated before drying. The material may be arranged in a matrix. The fiber may be polyester, nylon, cotton or a combination thereof. The fiber may be in a form that is knitted, woven and/or spun-bonded. The matrix may be a loose packed textile, a woven textile, a nonwoven textile or a needle punched textile. The nonwoven textile may be felted. The needle punched textile may be a nonwoven textile. The fiber may be a blend of two or more fibers. The cotton may be grown in Georgia, United States of America. The cotton may be natural, bleached, or a blend thereof. The metal oxide may be alumina, silicon dioxide, carbon, titanium, zirconium, copper (I), copper (II), sodium, magnesium, lithium, silver, iron (II), iron (III), chromium (VI), titanium (IV), zinc, or a combination thereof. The metal oxide may have a transformation state. For example, alumina may have a transformation state of gamma, eta, rho, chi, chi-rho, or theta. If the metal oxide is carbon, the carbon may be activated carbon. The material may contain the metal oxide on one or more sides. The material may contain the metal oxide on two sides. The metal oxide may saturate the material.

Also provided herein is a method of recovering oil from water. The method comprises contacting oily water with the herein described material that is capable of adsorbing organic compounds and maintaining the contact for a time sufficient to allow the material to adsorb a quantity of oil. The material may then be separated from the water and subsequently wrung to release adsorbed oil from the material. The act of contacting the oily water with the material may comprise submerging the material into the oily water or floating the material on the oily water. The material may be weighted. The material may be dropped or released into or onto the oily water from a boat, vessel, beacon, or buoy. The act of wringing the material may be accomplished by conveying the material through rollers.

### BRIEF DESCRIPTION OF THE DRAWINGS

FIG. 1 shows the concentration of compounds extracted from water captured by the OCAM, ranked by concentration in descending order. Concentrations are shown in mg per liter. See Table 2 (FIG. 3) for names of compounds. Aqueous sample derived from a tow of 4.12 sq. meter piece of organic compound adsorbing material (“OCAM”). Location was the Northwest side of Timbalier Island, Louisiana, USA. The duration of the tow was 30 minutes and the speed was 1 knot. The OCAM was submerged.

FIG. 2 shows Table 1, wherein the results of gas chromatography analyses of an aqueous sample derived from a tow of a 4.12 sq. meter of OCAM. Location was the Northwest side of Timbalier Island, Louisiana, USA. The duration of the tow was 45 minutes and the speed was 1 knot. The OCAM was submerged. Classes of compounds identified are shown along with their concentrations. Mean, standard deviation, and sample size also shown where calculable.

FIG. 3 shows Table 2, wherein the results of gas chromatography-mass spectrometry (GCMS) of an aqueous sample derived from a tow of a 4.12 sq. meter piece of adsorbent cloth. Tentatively identified compounds are listed (TIC). Location was the Northwest side of Timbalier Island, Louisiana, USA. The duration of the tow was 30 minutes and the speed was 1 knot. The OCAM was submerged. Specific compounds adsorbed by the material shown in order of concentration, along with their concentrations in mg per liter. Many of the compounds are known components of crude oil. At least alcohol is a known toxic component of the dispersant Corexit® (Nalco, Inc.). ***, probability of match to reference compound is > or = to 85%; ** is > or = to 50%, but <85%; * is <50%.

FIG. 4 shows a report of gas chromatography analyses on submerged-1, submerged-2, and surface-1 aqueous samples. Data is shown for two classes of petroleum hydrocarbons diesel range and oil range. Concentrations are given in mg⁻¹. The reference sample is 4-terphenyl-d14 for all analyses. (A) and (B) correspond to samples submerged-1-1 and submerged 1-2. (C)-(I) correspond to samples submerged 2-1 to 2-7. (J) corresponds to surface 3-1.

FIG. 5 shows a report of gas chromatograph mass spectrometry (GCMS) analyses performed on the submerged 1-1 aqueous sample in FIG. 4(A). Individual compounds collected by the OCAM are shown along with their estimated concentrations. Eighteen specific compounds identified, falling into four general classes petroleum hydrocarbons, alcohols, caffeine, and unknown. Some petroleum hydrocarbons are known components of crude oil. Some of the alcohols are known toxic components of a dispersant Corexit®.

FIG. 6 shows gas chromatographs produced from laboratory analyses performed on the submerged-1, submerged-2, and surface-1 aqueous samples.

FIG. 7 shows gas chromatographs produced from laboratory analyses performed on the adsorbent material used to sample during the submerged-1, submerged-2, and surface-1 experiments. The material was thawed from −20° C. to room temperature and its organic compounds extracted using dichloromethane (DCM) as a solvent.

FIG. 8 is a schematic example of the process for making the OCAM.

### DETAILED DESCRIPTION

The inventors have made the surprising discovery that certain combinations of fibers and metal oxides are sensitive to the presence of hydrocarbon compounds, which may be toxic and/or volatile. The level of sensitivity allows the herein described materials to adsorb organic compounds, even when the organic compounds are present in low concentrations. The organic compound adsorbing material described herein is capable of absorbing several times its own weight in oil, for example.

The sensitive nature of the organic compound adsorbing material make it an extremely useful composition for any of several applications related to the area of spill remediation, mitigation, environmental protection, and environmental monitoring.

### 1. Definitions

The terminology used herein is for the purpose of describing particular embodiments only and is not intended to be limiting. As used in the specification and the appended claims, the singular forms “a,” “and” and “the” include plural references unless the context clearly dictates otherwise.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. Organic Compound Adsorbing Material (“OCAM”)

Provided herein is an organic compound adsorbing material (“OCAM”). The OCAM is made of a fiber and a metal oxide. The OCAM may be arranged as a matrix. The OCAM is impregnated, saturated, or coated with a metal oxide.

The OCAM may be arranged as a matrix by any a needling process. For example, the matrix may be formed by needle felting. Needle felting, sometimes referred to as needle punching or simply needling, is a process used in the textile industry in which an element such as a barbed needle is passed into and out of a fabric to entangle the fibers. Needle felting is described for example in U.S. Pat. Nos. 5,989,375; 5,388,320; 5,323,523; 3,829,939; and 6,405,417, all of which are incorporated by reference herein.

The OCAM may be any size or shape. The OCAM may be in the form of one or more long “fingers” or in the form of a sheet. Often, the size of the area to be treated, monitored, or assessed with the OCAM will dictate the size of the OCAM. The OCAM may be between 2 sq. feet and 5,000 sq. feet; between 10 sq. feet and 4,500 sq. feet; between 100 sq. feet and 4,000 sq. feet; between 500 sq. feet and 3,500 sq. feet; between 1,000 sq. feet and 3,000 sq. feet; between 1,500 sq. feet and 2,500 sq. feet; between 1,750 sq. feet and 2,250 sq. feet, or between 2,500 sq. feet and 5,000 sq. feet. The matrix may be greater than 5,000 sq. feet. The matrix may be 1,500 sq. feet.

The OCAM may have a border. The border may be derived from a plastic, vinyl, denim, or a combination or blend thereof. The border may be weighted. The border may have a width of between 0.1 inches and 0.5 inches; between 0.5 inches and 1 inch, between 1 inch and 3 inches, between 3 inches and 5 inches, or between 5 inches and 10 inches. The border may have width of a foot or several feet. The border may completely surround the fiber and metal oxide. The border may surround only a portion of the fiber and metal oxide.

a. Fiber

The fiber may be natural or synthetic. The fiber may be cotton, polyester, and/or nylon. The fiber may be a blend of two or more of cotton, polyester, and nylon. The fiber may be a non-continuous short filament or a continuous filament. Non-continuous filaments are in short lengths and spun and twisted together to form long threads of yarn. Continuous filaments are long filaments of fiber that are plied together to form continuous bundles of fiber, yarn, or rope. The fiber, yarn, or rope may be of any thickness. The thickness of the fiber, yarn, or rope may be predicated on the type of matrix desired. The thickness may be less than 0.1 inches. The thickness may be between 0.1 inches and 0.5 inches, between 0.5 inches and 1 inch, between 1 inch and 3 inches, between 3 inches and 5 inches, or between 5 inches and 10 inches. The thickness may be greater than 10 inches. The fiber may be knitted fiber, woven fiber, non-woven fiber, or spun-bonded fiber.

(1) Cotton

The cotton may be natural and/or bleached. The cotton may be a blend of natural and bleached cotton. The cotton may be grown in the U.S., the Soviet Union, the Peoples Republic of China, India, Brazil, Pakistan, and/or Turkey. Asiatic cotton has fibers less than one inch (2.5 cm) long and rather coarse in texture. It is grown mostly in India, Iran, China, and Russia. Peruvian cotton has fuzzy, almost wool-like fibers. Brazilian cotton is a perennial cotton with long, silky fibers.

Cotton grown in the U.S. may have been grown in Alabama, Arizona, Arkansas, California, Georgia, Louisiana, Mississippi, Missouri, New Mexico, North Carolina, Oklahoma, South Carolina, Tennessee, Florida, Kansas, and/or Virginia. The cotton may have been grown in Georgia and/or Alabama, United States. The climate and/or soil in Georgia and Alabama impart desirable surface characteristics to the cotton. The climate and/or soil in Georgia and Alabama also provide an optimal environment to grow longer cotton fibers. The surface characteristics and length of Georgia and Alabama cotton provide increased cotton surface area and thus a greater ability to hold more metal oxide and adsorb contaminants, such as oil.

Other types of cotton include Egyptian cotton, Sea Island cotton, and Pima cotton. Egyptian cotton is a fine, lustrous cotton and has long and thinner fibers. This cotton fiber is light brown in color and are ideal for making strong yarns. Sea Island cotton has a long staple and silky texture, which allows it to be used in the finest cotton counts. Pima cotton belongs to the extra long staple types of cotton and has long, smooth fibers.

The cotton fiber may be a natural polymer of cellulose. The melting point of the cotton fiber may be between 250° C. and 280° C. or between 260° C. and 270° C. The specific gravity of the cotton fiber may be between 1 and 3, between 1.2 and 2.5, between 1.2 and 2, between 1.5 and 3, or between 1.7 and 2.2. The specific gravity of the cotton fiber may be between 1.27 and 1.61.

(2) Polyester

Polyester thread or yarn may be used. Industrial polyester fibers, yarns and ropes, such as those used in conveyor belts, safety belts, coated fabrics and plastic reinforcements with high-energy absorption may also be used. The polyester fibers may be spun together with natural fibres to produce a matrix having blended properties. Synthetic fibers can create materials with superior water, wind and environmental resistance compared to plant-derived fibers.

Polyester fabrics and fibers are extremely strong. Polyester is very durable: resistant to most chemicals, stretching and shrinking, wrinkle resistant, mildew and abrasion resistant. Polyester is hydrophobic in nature and quick drying. Polyester retains its shape and hence is good for making matrices exposed to harsh conditions. Polyester is easily washed and dried.

(3) Nylon

Nylon is made of repeating units linked by amide bonds and is frequently referred to as polyamide (PA). Nylon was the first commercially successful synthetic polymer. There are two common methods of making nylon for fiber applications. In one approach, molecules with an acid (—COOH) group on each end are reacted with molecules containing amine (—NH2) groups on each end. The resulting nylon is named on the basis of the number of carbon atoms separating the two acid groups and the two amines. These are formed into monomers of intermediate molecular weight, which are then reacted to form long polymer chains. Nylon is a thermoplastic silky material, first used commercially in a nylon-bristled toothbrush.

Nylon fibers may be spun together with natural fibres to produce a matrix having blended properties. Nylon fibers can impart durability, abrasion resistance, resiliency, resistance to insects, fungi, molds, mildew, rot, various chemicals, and animals, for example.

b. Metal Oxide

The metal oxide may be any compound formed by a metal and oxygen in which the oxygen has an oxidation number of −2. For example, the metal oxide may be one or more of alumina, silicon dioxide, carbon, titanium, zirconium, copper (I), copper (II), sodium, magnesium, lithium, silver, iron (II), iron (III), chromium (VI), titanium (IV), and zinc. The carbon may be activated carbon. The activated carbon may be a form of carbon that has been processed to make it porous and thus to have a very large surface area available for adsorption or chemical reactions. The alumina may have a transformation state of gamma, eta, rho, chi, chi-rho, or theta. The transformation state may impart contaminant selectivity or may enhance contaminant adsorption. The alumina may be a gel, pseudoboehmite, and/or bayerite alumina.

c. Matrix

The material may be in the form of a matrix. The matrix may be a loose packed textile, a woven textile, a nonwoven textile or a needle punched textile.

The non-woven textile may be made from fibers bonded together by chemical, mechanical, heat and/or solvent treatment. The nonwoven textile may be felted. The nonwoven textile may be a flat sheet made directed from separate fibers. The nonwoven textile may not be made by weaving or knitting and may not require converting fibers to yarn. Nonwoven fabrics may provide one or more specific functions, such as absorbency, liquid repellence, resilience, stretch, softness, strength, flame retardancy, washability, cushioning, and/or filtering. Any of these properties may be combined to create fabrics suited for specific jobs, while achieving a good balance between product use-life and cost.

The non-woven textile may be felted. Felt is a nonwoven textile that may be produced by matting, condensing and pressing woolen fibers. The felt may be made by wet felting, wherein natural wool fibers are stimulated by friction and lubricated by moisture. The fibers may move at a roughly 90 degree angle towards the friction source and then away again. This process results in tacking stitches. Woolen fibers, when aggravated, bond together to form a textile.

The woven textile may be formed from interlaced fibers or yarn. The fibers or yarn may be interlaced on a loom. The woven textile may be created via one or more of the following types of weaves: plain, satin, twill, and/or computer-generated interlacings.

The needle-punched textile may be made by mechanically orienting and interlocking fibers of a spunbonded or carded web, whereby barbed felting needles continually pass into and out of the webbed fibers. The needle punched textile may be made on a loom so that the fibers may be interlocked in a one-dimension textile. The loom may be a felting loom, a structuring loom or a random velour loom.

The spunbonded web may be produced by deposition extruded, spun filaments onto a collecting belt in a uniform random fashion followed by bonding the fibers. The fibers may be separated during deposition onto the collecting belt by air or electrostatic charges. The bonding may impart strength and integrity to the web of filaments via heated rolls or needles to partially melt the polymer and fuse fibers together. The polymer may be a high molecular weight polymer and/or a broad molecular weight distribution polymer. The polymer may be polypropylene, polyester, nylon, polyethylene, polyurethane, rayon, or a combination thereof.

### 3. Method of Making OCAM

The herein described OCAM may be manufactured by a method of contacting the fiber or matrix with the metal oxide to form a metal oxide coated fiber or a metal oxide coated matrix. In other words, the fiber may be contacted with a metal oxide prior to the fiber being arranged in a matrix, or the fibers may be arranged into a matrix, whereby the matrix is then contacted with the metal oxide. By contacting the fiber and/or matrix with a metal oxide, the metal oxide is impregnated into or on the fiber and/or matrix. The metal oxide matrix may then be dried to form the OCAM.

The metal oxide may be applied to the fiber or matrix via spin coating, spray coating, dip coating, die coating, chemical vapor deposition, incipient wetness, curtain coating, vacuum impregnation, saturation spraying, and/or low temperature impregnation, for example. The metal oxide may be applied to the fiber or matrix by atomizing the metal oxide and applying the atomized metal oxide to the fiber or matrix via air pressure, for example. The metal oxide may be applied to one or more sides of the matrix. The metal oxide may be applied to two sides of the matrix at the same time or, alternatively, to one side and then another side. The fibers or matrix may be saturated with the metal oxide. After the matrix-metal oxide composition has been formed, it may or may not be acid treated before drying. Acid treatment may increase OH− and/or H+ ions on the surface of the matrix-metal oxide material and thereby enhance the adsorption of contaminants.

The matrix-metal oxide may be dried by any process. Such processes include fluid bed drying, air drying, single pass oven drying, double pass oven drying, and/or three pass oven drying. The matrix-metal oxide may be dried at between 110° C. and 150° C., 150° C. and 350° C., between 200° C. and 300° C., or between 225° C. and 275° C. The matrix-metal oxide may be dried for between 3 minutes and 10 hours, 5 minutes and 10 hours, 10 minutes and 10 hours, between 30 minutes and 9.5 hours, between 1 hour and 9 hours, between 1.5 hours and 8.5 hours, between 2 hours and 8 hours, between 3 hours and 7 hours, or between 4 hours and 6 hours. The matrix-metal oxide may be dried at room temperature or outside at air temperature for a period of time.

### 4. Methods of Use

The OCAM may be used to clean water harboring contaminants such as oil, diesel, ethanol, 2-(methylthio)ethanol, 2-butoxyethanol, 3-pentanone, phenol and phenol-related compounds, 4-methyl-phenol, benzene and benzene-related compounds, 1,2-benzene-dicarboxylic acid, butyl 2-ethylhexyl ester, 9-methyl-Z-10-tetradecen-1-ol acetate, cyclic octa-atomic sulfur, n-hexadecanoic acid, 2-butoxy-ethanol, (Z)-9-hexadecenoic acid, methyl ester, 2-[2-(2-butoxyethoxy)ethoxy]-ethanol, octadecanoic acid, 4-methyl phenol, Z-9-octadecenamide, 2-methylthio-ethanol, Z-9-tetradecenoic acid, oxybenzone, 1-eicosanol, caffeine, ethylcyclodo-decane, 2(1H)naphthalenone, 3,5,6,7,8,8a-hexahydro-4,8a-dimethyl-6-(1-ethyl-ethenyl), 1-dotriacontanol, hexadecahydro-pyrene, nC-17 heptadecane, and C-2 naphthalene.

The OCAM is capable of binding between 1 and 3.5 gallons, between 1.5 and 3 gallons, between 2 and 3 gallons, or between 2.5 and 3.5 gallons of oil or diesel for every pound of OCAM used as described below according to ASTM methods, for example, ASTM D-117.

The OCAM may be used in a variety of applications including, but not limited to, surface oil adsorption, industrial clean-up, adsorption of sunken oil, fill for adsorbent booms, environmental monitor, oil containment, a desalination filter, and/or as an estuarine filter. The OCAM may be floated on a water surface or submerged. The OCAM may be submerged to any depth. For example, the OCAM may be allowed to sink into an oil plume at some depth below a water surface. The OCAM may be sunk to depths of greater than 5 feet, 50 feet, 100 feet, 500 feet, 1,000 feet, 5,000 feet, 10,000 feet, 20,000 feet, 30,000 feet, 40,000 feet, 50,000 feet, 100,000 feet or more. The OCAM may be appropriately weighted so as to be submerged.

The OCAM may be tied to a buoy, beacon, vessel or boat, for example, whereby the OCAM may be reeled in from the water surface or from a water depth for subsequent analysis and/or wringing. The oil may be recovered by wringing the OCAM. The wringing may be conducted via rollers, through which the OCAM may be conveyed and wrung. The recovered oil may then be stored for subsequent use.

a. Surface Oil Adsorption

The OCAM may be deployed as one or more sheets over large areas of water, to be reeled in. The reeled sheets may be wrung, thereby recovering the oil and produced waters, possibly to be reused. The OCAM be made in such a way that it is only slightly negatively buoyant, so as to expose both sides of the material to surface oil.

b. Industrial Clean-Up

The OCAM may be deployed for industrial clean-up of oil spills on land, in factories, refineries, tank farms, etc. If desired, oil may be recovered from such a collection as well.

c. Adsorption of Sunken Oil

The OCAM may be deployed for the adsorption of sunken oil, which may be concentrated at a given depth. It is now known that some oil, either in combination with dispersant, or simply weathered, having lost its low molecular weight compounds, can sink and, because of its near-neutral buoyancy or because of the application of dispersants at depth, remain in deep water, accumulate on a deep picnocline, or sink to the bottom. This has been shown to be the case 17 km from an oil spill site, where an accumulation of oil has been sighted at a depth of 3,600-4,000 ft. (Hazen et al., Science, October 8; 330(6001):204-8). In this case, the adsorbent material may be weighted, made to be negatively buoyant, or mechanically compressed to rid it of trapped air.

d. Fill for Adsorbent Booms

The OCAM utilized described herein may be more effective at adsorbing oil (30-40× its own weight) than the absorbent booms currently being used, whether they consist of natural or manufactured material.

e. Environmental Monitor

Water samples are often taken to determine the presence and/or concentrations of pollutants. Such pollutants include petroleum hydrocarbons in waters from which seafood, and in the case of freshwater, drinking water is drawn. Concentrations may be too low to detect by conventional methods. Furthermore, some environmental insults are short in duration and/or intermittent, making it difficult to detect if the temporal scale of the sampling is not in alignment with a punctuated or randomly occurring pollution event. The OCAM may be used as a sampler that is cumulative through time and space, covering a period of time and being exposed to a given volume of water. Because the pollutant would be captured by the OCAM, it could be identified as one or more specific compounds and traced.

As an environmental monitor, water may be gently pumped, for example, to force water through a filter unit containing the OCAM. A gauge may be incorporated into the unit to measure the amount of water passing through the unit so as to accurately calculate concentrations of the contaminant in units, for example a standard unit such as mg per liter or μg per liter.

f. Desalination Filter

The OCAM may be used as a filter for desalination units. For example, the OCAM may be secured in a vertical position and then, optionally, staggered across an entrance to a desalination unit. In that way water entering the desalination unit impinges on the OCAM. Once the OCAM is saturated with oil and other contaminants, any further oil and contaminants that come into contact with the OCAM are repelled away from the OCAM (i.e. oil and other contaminants do not cross the OCAM and, instead, are repelled).

g. Estuarine Filter

The OCAM may be used to decontaminate embayments, which may be enclosed or semi-enclosed. The highly sensitive character of this material makes it possible to use as an open-water petroleum hydrocarbon filter in, for example, small embayments in estuaries with low tidal flux. The OCAM may be effective even where low concentrations of toxic petroleum hydrocarbons or dispersant are dissolved, suspended, or emulsified in the water. The OCAM may be secured in a vertical position and then, optionally, staggered across an entrance to an embayment. In that way water entering or leaving the embayment impinges on the OCAM with each tidal change. Petroleum hydrocarbon concentrations could therefore be reduced in contaminated waters. The OCAM may be changed or wrung out at regular intervals during or after a spill event. Deployment of the OCAM would help to protect valuable fisheries.

### 5. Kit

Provided herein is a kit, which may be used for analysis, monitoring, or treating an oil spill. The kit may comprise metal oxides, and fibers and/or matrices as described herein. The kit can further comprise instructions for using the kit and conducting the analysis, monitoring, or treatment.

The kit may also comprise one or more containers, such as vials or bottles, with each container containing a separate reagent. The kit may further comprise written instructions, which may describe how to perform or interpret an analysis, monitoring, treatment, or method described herein.

The present invention has multiple aspects, illustrated by the following non-limiting examples.

### EXAMPLES

### Example 1

### OCAM

Georgia cotton fibers were subjected to needle felting whereby a cotton fiber matrix, having a width of 0.91 meters, a length of 4.54 meters, and a surface area of 4.12 m², was prepared. The sheet was then subjected to alumina saturation spraying on both sides of the sheet. The sheet was then dried and used in the following described field tests.

### Example 2

### Materials and Methods for Field Tests

With respect to field deployment, two sites were chosen for the field tests. The vessel used for the exercise was LUMCON's RJV Whiskey Pass, a 9 m, single-hull, open-construction boat, powered by two high-powered outboard motors.

The first site (Site 1) was Timbalier Island, south of Cocodrie, La. at (29° 05′ N, −90° 32′ W). Deployment on the NW tip of the island was performed, because of a suspected meso-scale eddy in this region. This was due to known prevailing longshore currents from the east, and the crescent shape of the island, being bowed to the south. It was likely that submerged or surface oil would be present here.

At this site, we used two submerged sampling units, in sequence. Each unit consisted of a 0.9×4.5 m piece of the sheet-like, adsorbent material, secured to two pieces of steel re-bar one at each end. The material was wrapped around the re-bar and secured with cable-ties. The material was towed from a pole extending to the port side of the boat, attached to the bow. The material was not permitted to extend beyond the stern of the boat, in order to avoid potential contamination by petroleum hydrocarbons released by the boat's engines.

The first trial was initiated at 11:08 hrs. The material was pulled by the boat, mostly submerged, at 0.5-0.7 knots through the water for 30 mins. The front was repeatedly sampled. Not all of the adsorbent material was submerged, because of its buoyancy in seawater. 75% of it was completely submerged; the remainder was intermittently submerged. The entire bottom face of the material, however, was in contact with the water at all times.

When the material was retrieved, it was wrung of its liquid. The liquid was captured in EPA standard prep. amber jars. All sample jars were labelled, returned to the laboratory, and stored at 4° C. The used adsorbent material was placed in black, heavy-duty, opaque plastic bags, labelled, returned to the lab, and stored at −20° C.

A second trial was performed in the same region. Before trying a second trawl with the material, we added weights to the bottom bar. 2-4 lbs weights were also placed on the front re-bar support. Three extra pieces of re-bar were also placed at regular intervals along the material, weighted with one diving 1-lb weight on each. Four pounds of lead weights were also added to the tail re-bar to insure that it would sink. This configuration was designed to hold the material in a concave manner, at an average angle of 45° to the surface. This allowed the material to sit completely submerged, with all sides in contact with the oncoming water.

The second submerged unit was deployed at 1312 hrs and trailed it for 45 mins. It remained completely submerged for that time. The speed of trawling was 1.0 knots. In this instance, after retrieving the material, we used a clothes hand-wringing technique to collect liquid from the material.

We performed a similar trial at Rock Island near Cocodrie, La. (29° 14′ 54″ N, −90° 39′4′ W), at the north end of Terrebonne Bay, where the salt marshes were reported to have been oiled by the spill. In this deployment, the purpose was to test the material at the water's surface and attempt to capture any petroleum hydrocarbons floating on the surface. Upon arriving there, we observed booms on the island positioned for retrieval, indicating that the area may have been oiled in the recent past.

The head and tail pieces of this sampling unit were constructed of 2.5 cm diameter wooden dowel rods. This insured that the material would stay afloat and spread-out. This second sampling unit was also 0.91×4.54 m in size (4.12 m²) and was deployed from the port side of the boat. It was pulled for 45 mins, beginning at 1505 hrs, at 0.6-0.8 knots.

With respect to laboratory analyses, within one week, all samples and used materials were couriered to the Sherry Laboratories, Lafayette, La. for chemical analysis. Initial analysis was by gas chromatography (GC) to detect the classes of petroleum hydrocarbons potentially present, utilizing primarily number of carbons as an indicator. Once the classes were determined to be consistent with those known to occur in crude oil, a decision was taken to follow through with analysis by gas chromatography mass spectrometry (GCMS), in order to identify specific compounds present, their relative abundances, and their concentrations.

### Example 3

### Results of Field Observations

With respect to Site 1, a front with some accumulated flotsam was observed, suggesting eddy-type formations. The boat's generally circular drift while sampling also suggested the presence of a small meso-scale eddy in this region.

When the first piece of material was retrieved, it was clearly discolored, with a blackish tint. We retrieved the unit and wrang it as much as possible (first attempt) into 950 ml EPA standard prep amber jars, pre-labeled. We did not obtain much material from this run perhaps 1-2 jars of liquid plus dissolved and suspended materials.

When the second submerged sampling unit was retrieved, almost all of the sampling material was very dark dark grey to black. It was also apparent from the bottom of the material that we had touched bottom sediment with it. Using a more efficient hand-wringing process with the second submerged unit, we increased the amount of liquid collected by 7-fold.

The third surface-oriented sampling unit proved to be very buoyant. While pulling it, it became evident that the upper side was remaining generally dry. Water was not washing over the top of the unit. Water did appear to bead up on the top after several minutes, however, and continued to accumulate there. What was most interesting was that these beads of water were quite clear—not in the least discolored, while the bay water was a highly discolored greenish/brown. When we retrieved the material, it appeared to have absorbed hardly any liquid. It was very light in weight and color. What was striking was that the top side of the material had its usual rough cotton texture, but the underside had a “slimy” feel to it smooth and silky, as if it had adsorbed something on its surface. Some liquid was wrung from the material, but only small amount was obtained, perhaps 10-20 ml. The liquid sample and material was labeled and stored as described above.

### Example 4

### Results—Laboratory Analyses

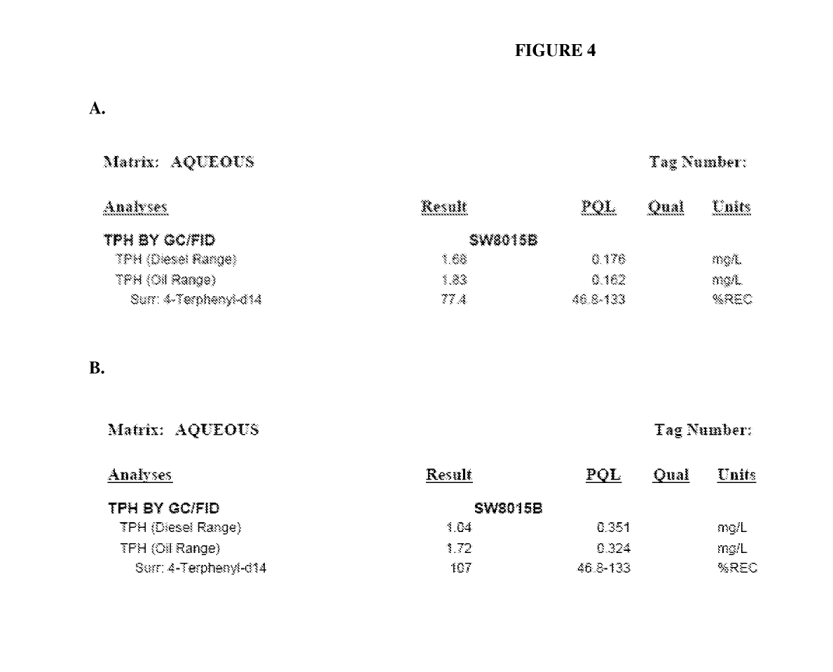

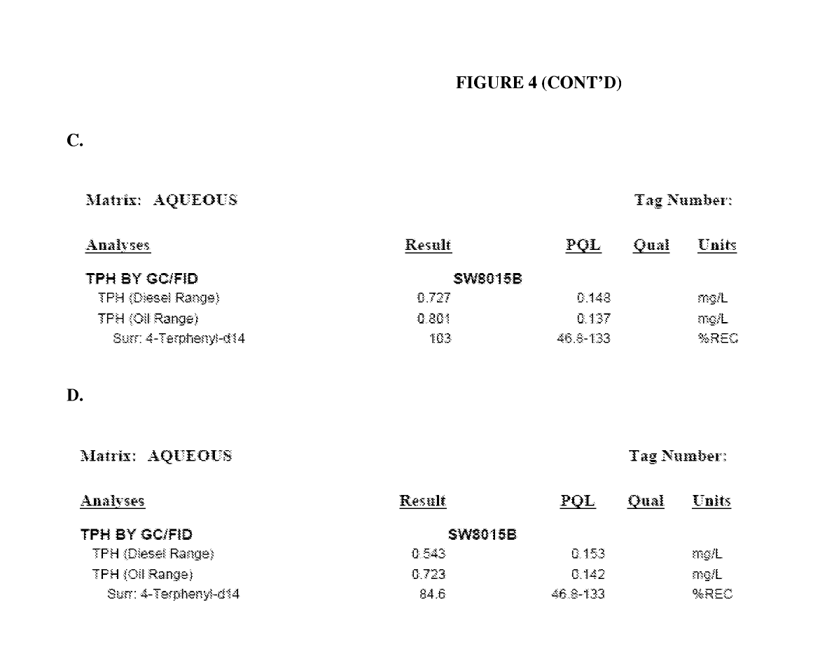

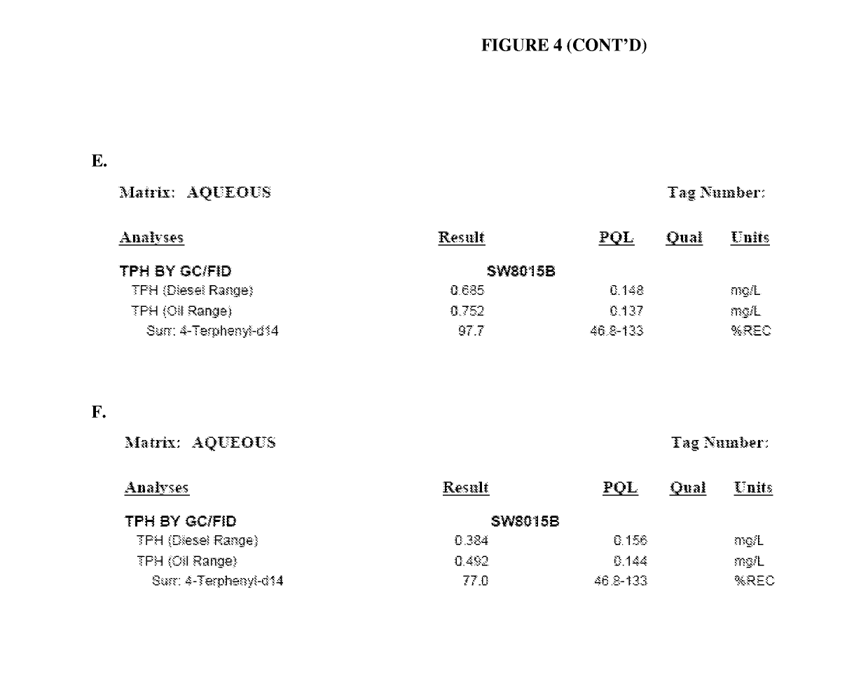

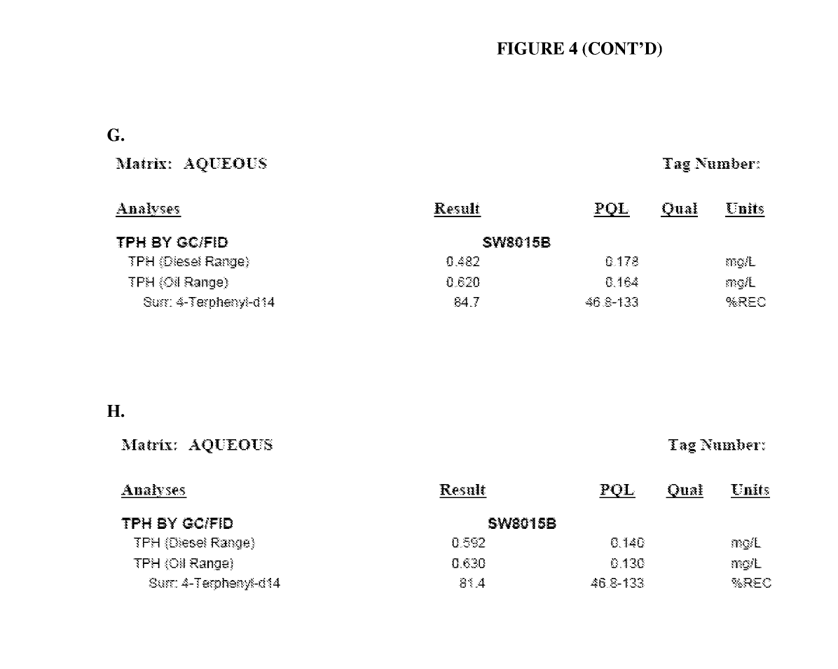

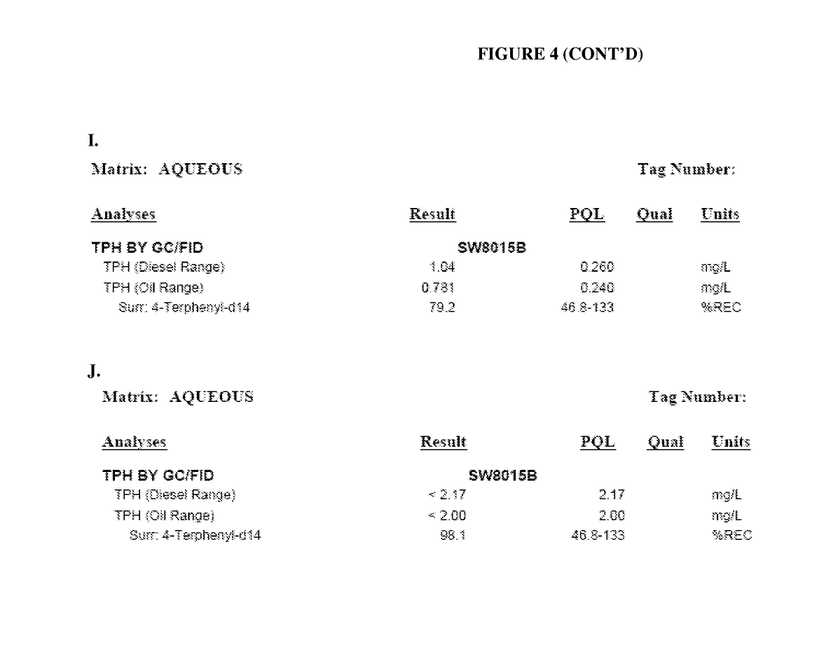

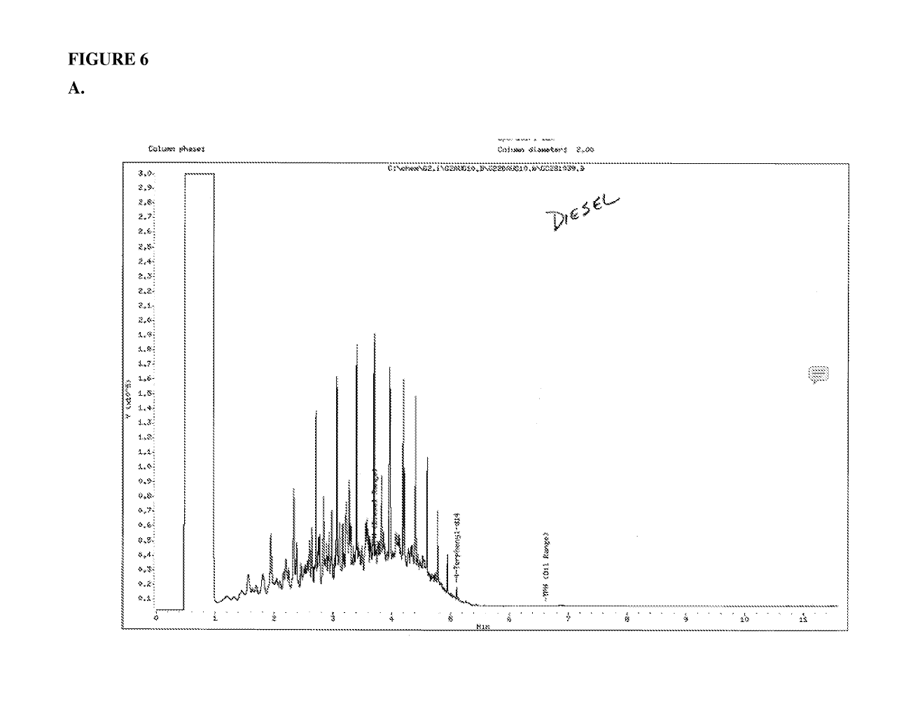

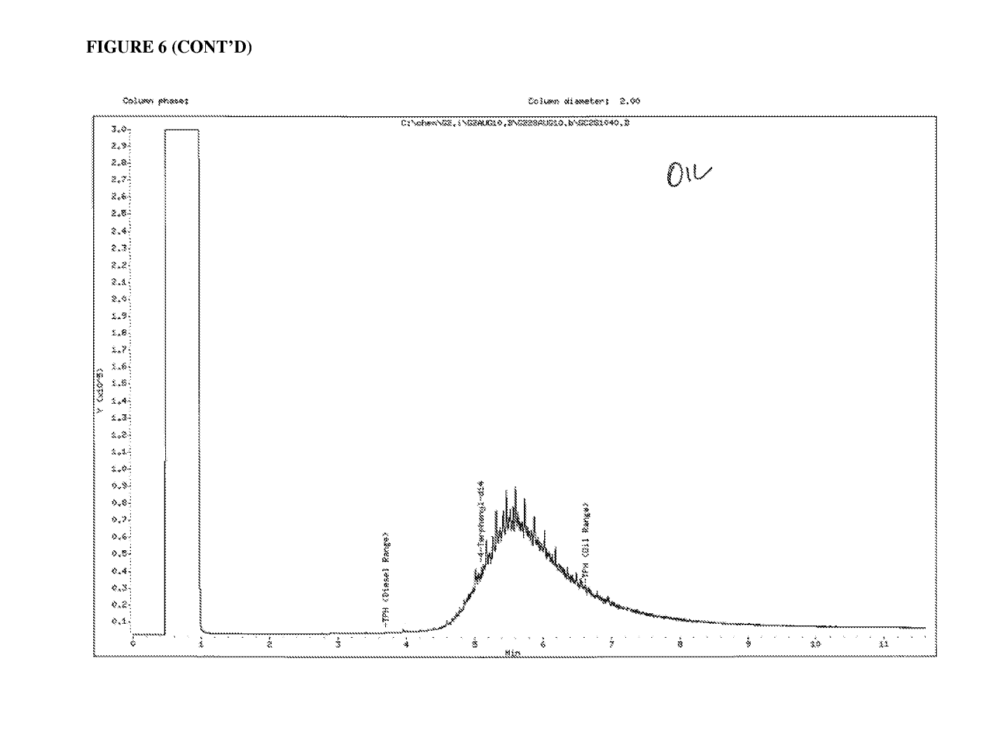

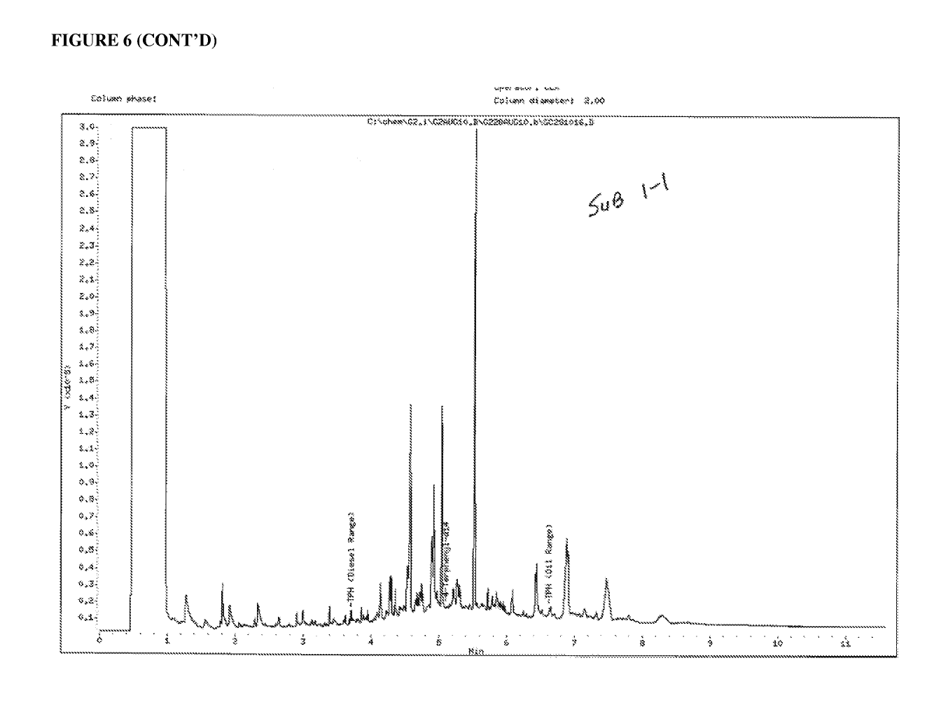

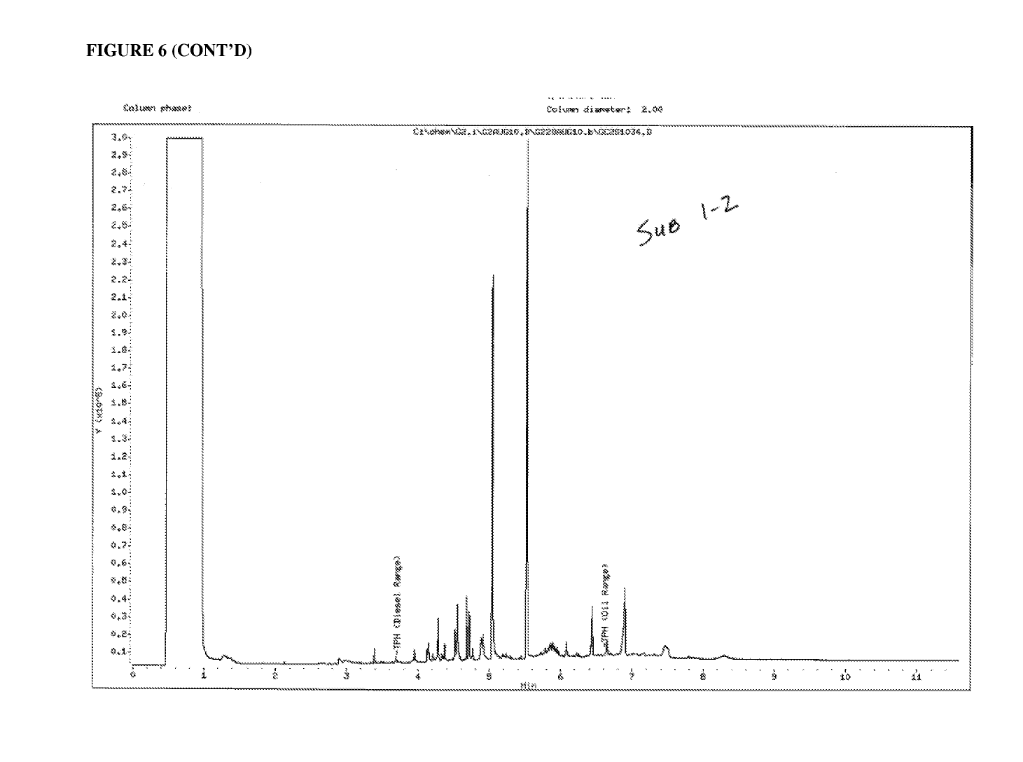

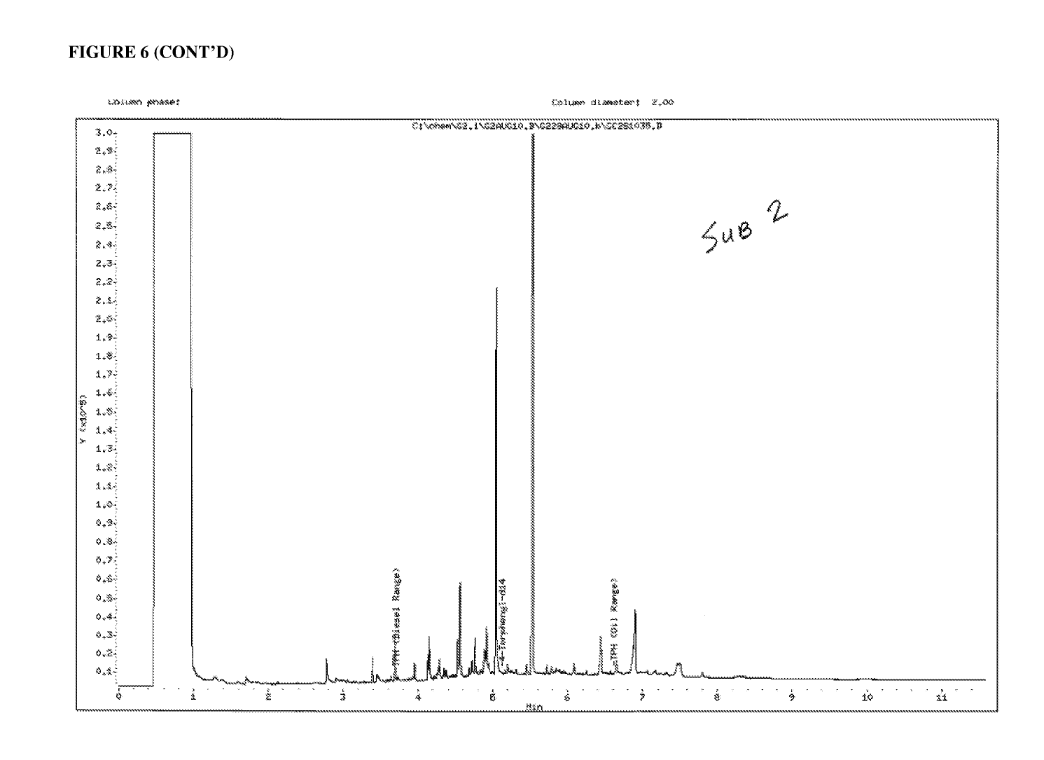

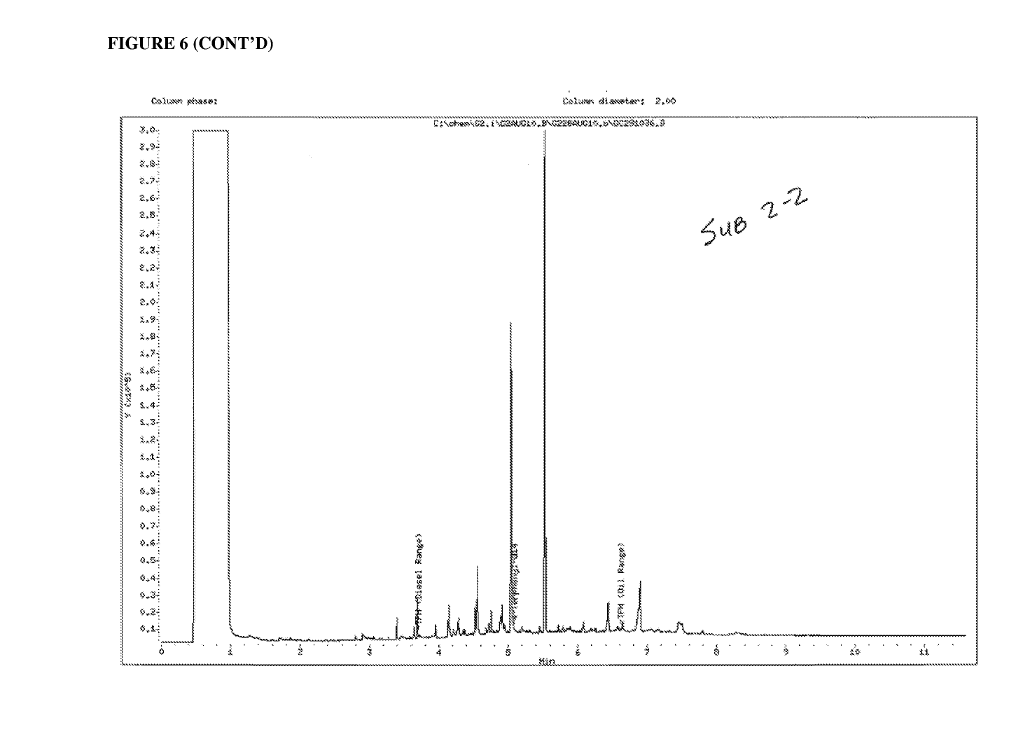

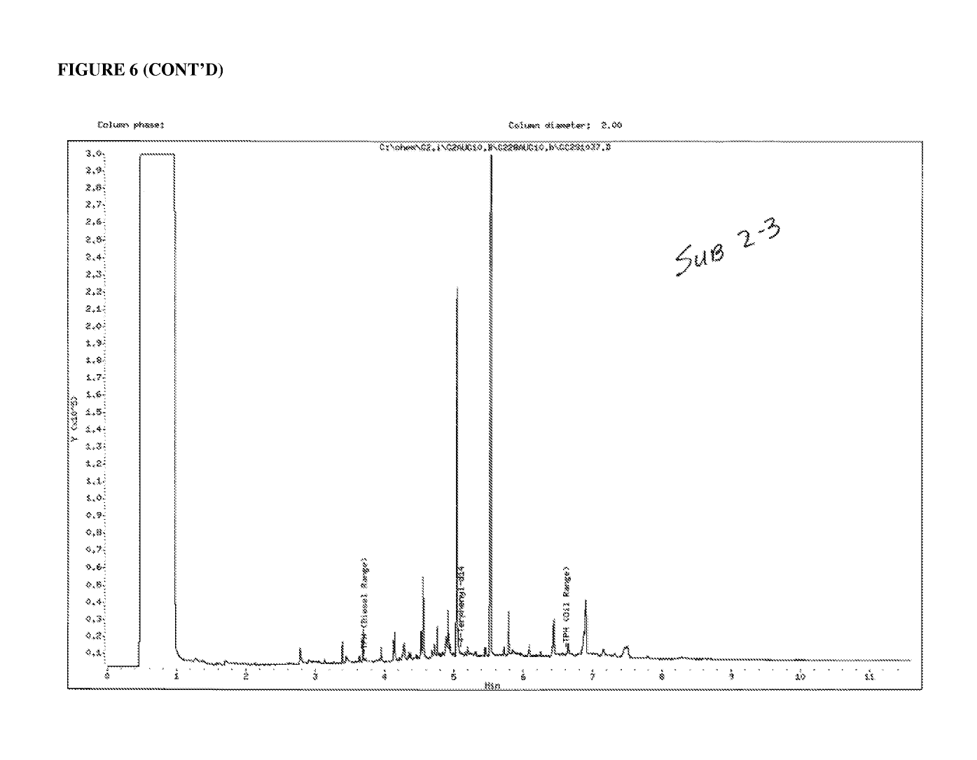

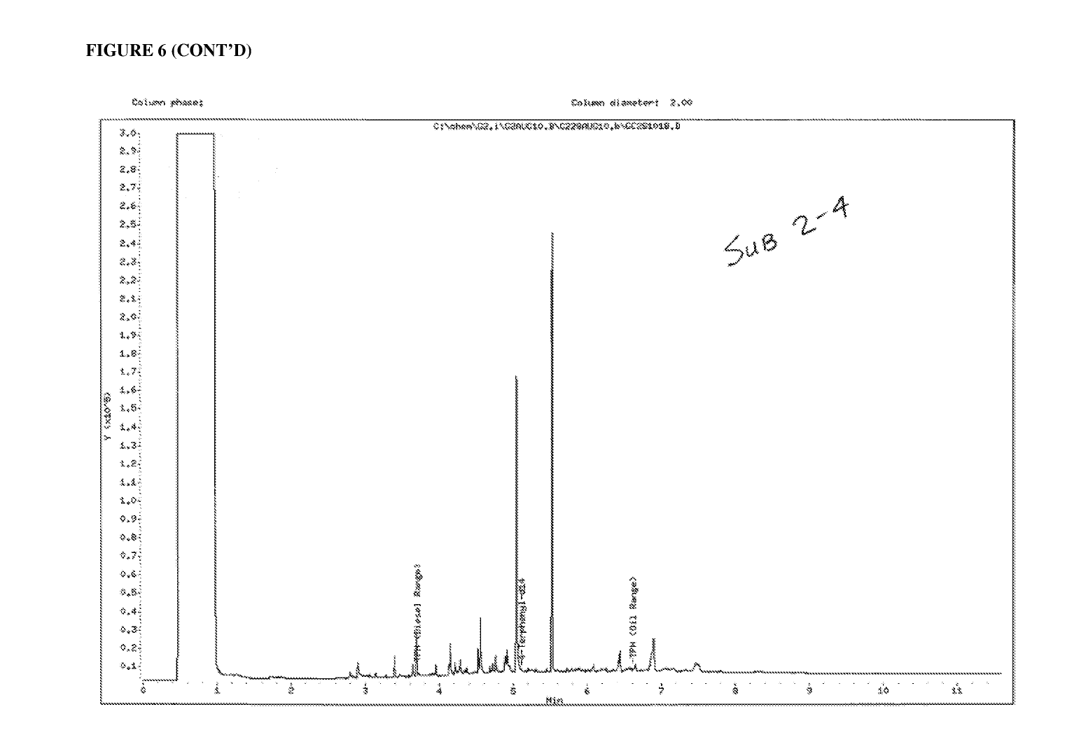

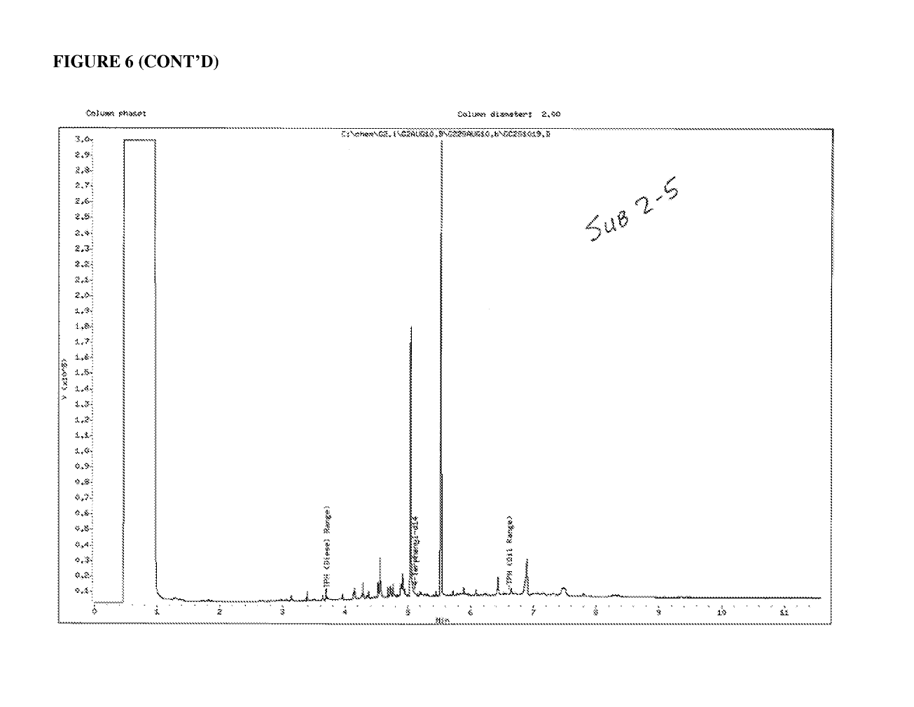

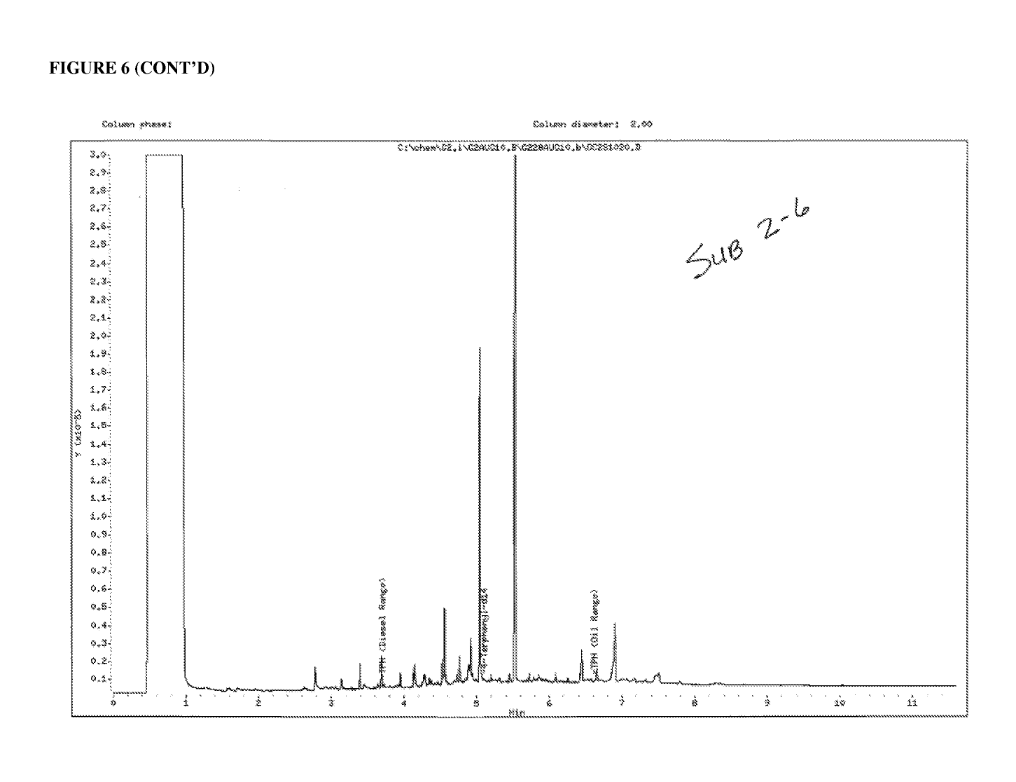

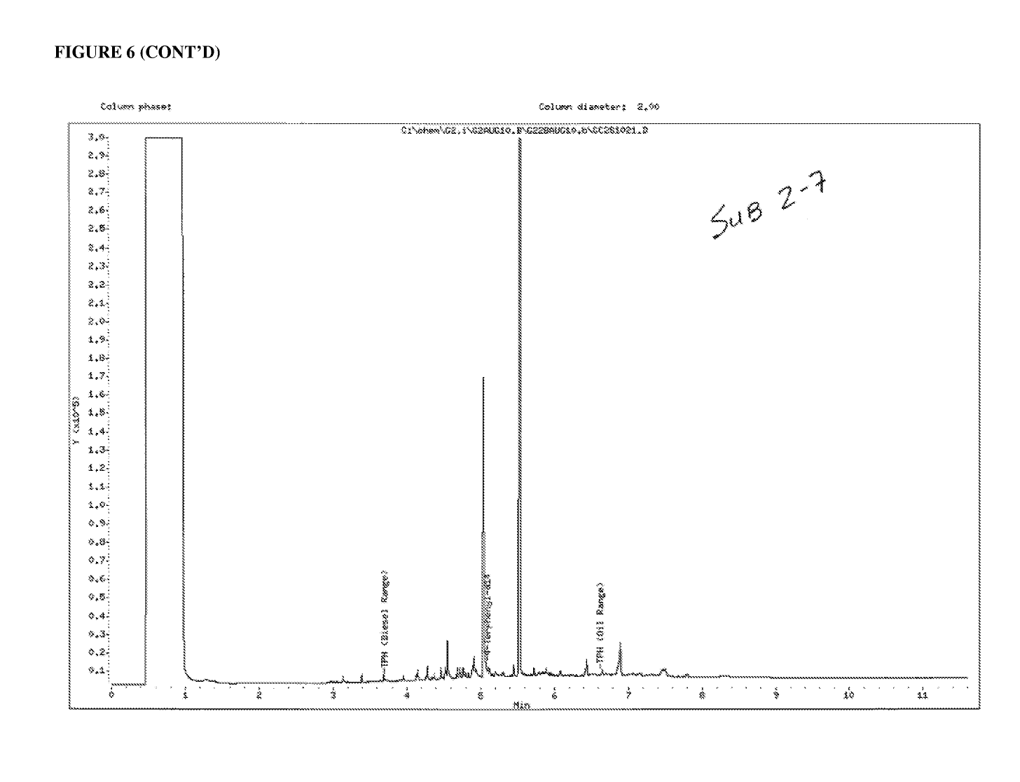

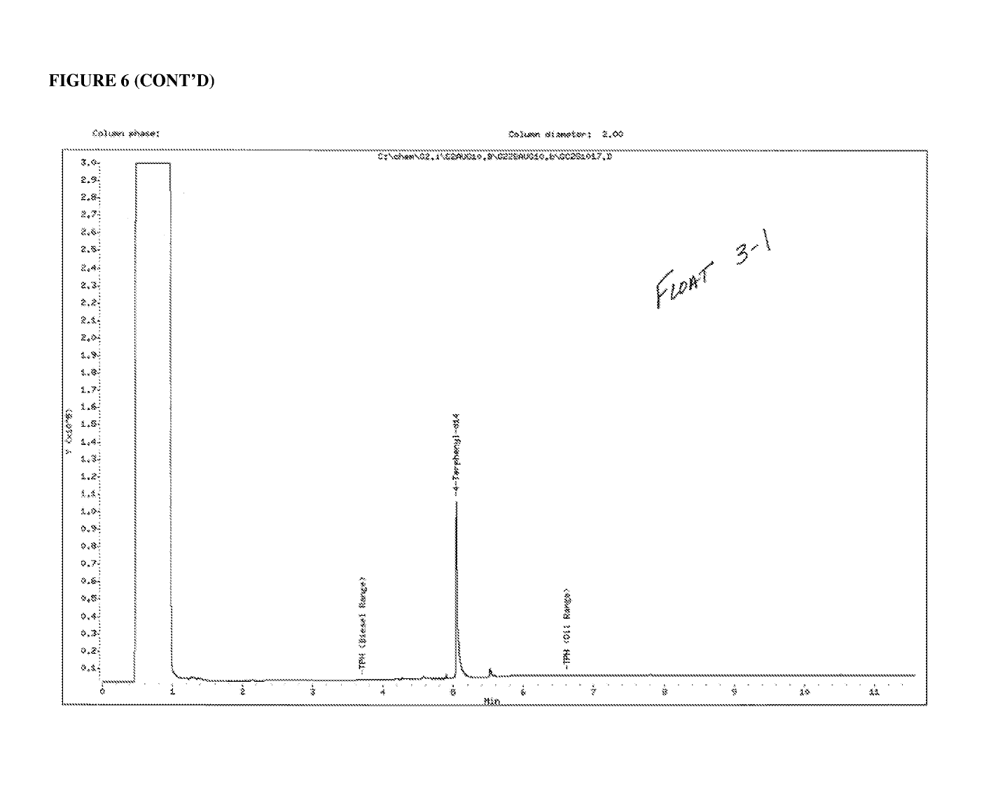

Analyses of all samples by GC revealed the presence of petroleum hydrocarbons in all cases—in the liquid samples and in the material (FIGS. 4 and 6). The two most prominent groups fell into the ranges of “diesel” and “oil”. The estimated concentrations of these classes in the water samples drawn from the material are listed in Table 1. The pads exhibited the same class peaks, although lower in abundance.

The surface trial yielded a sufficient amount of liquid for preliminary GC analysis, but not for GCMS. In fact, the report of compounds “<2.0 mg 1-1” shown in Table 1 are only indicative of compounds present in amounts below the detection limits of the instrument.

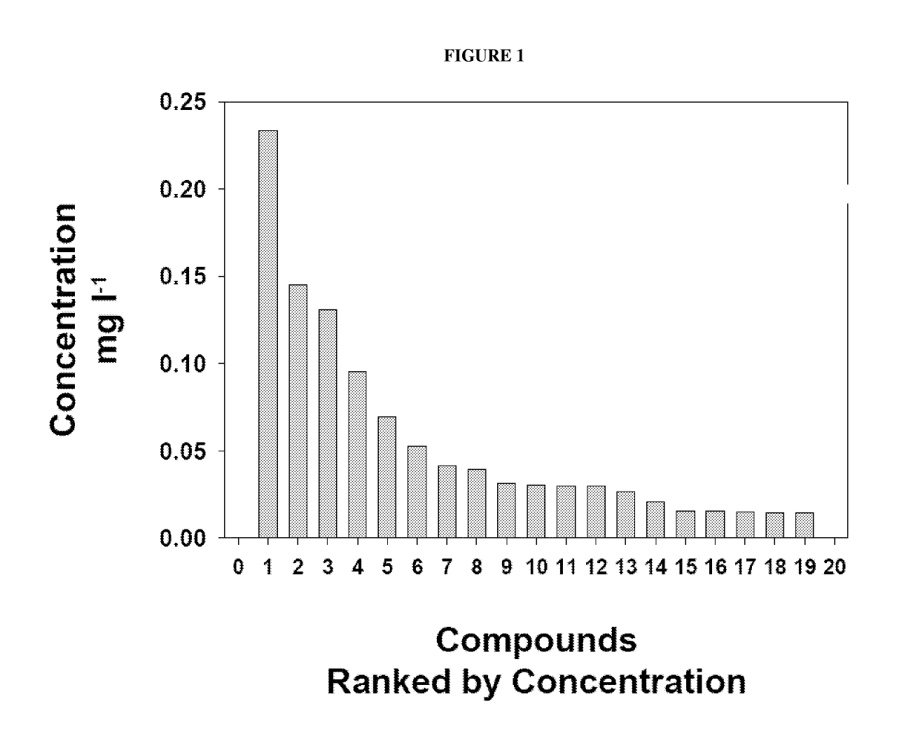

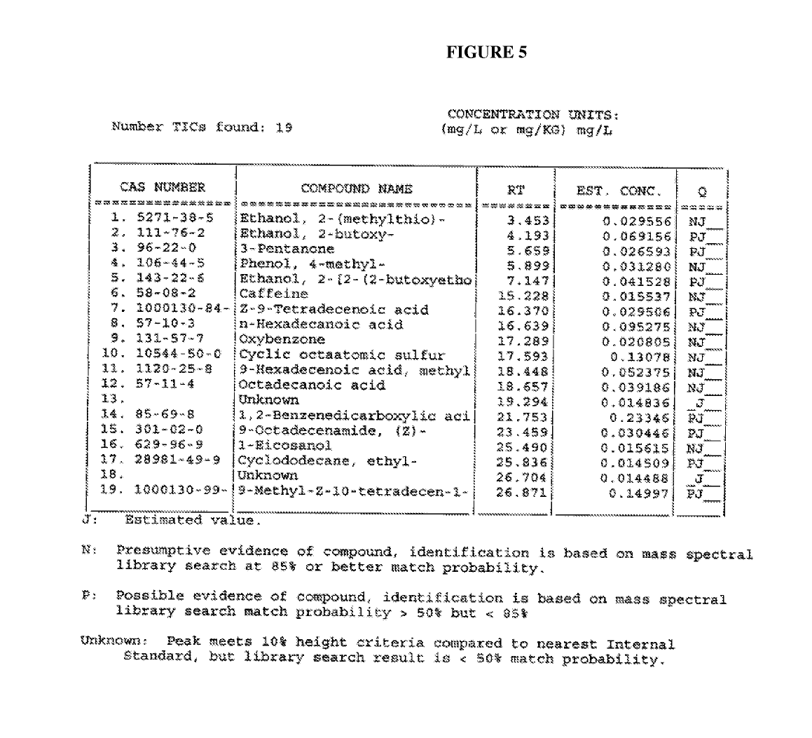

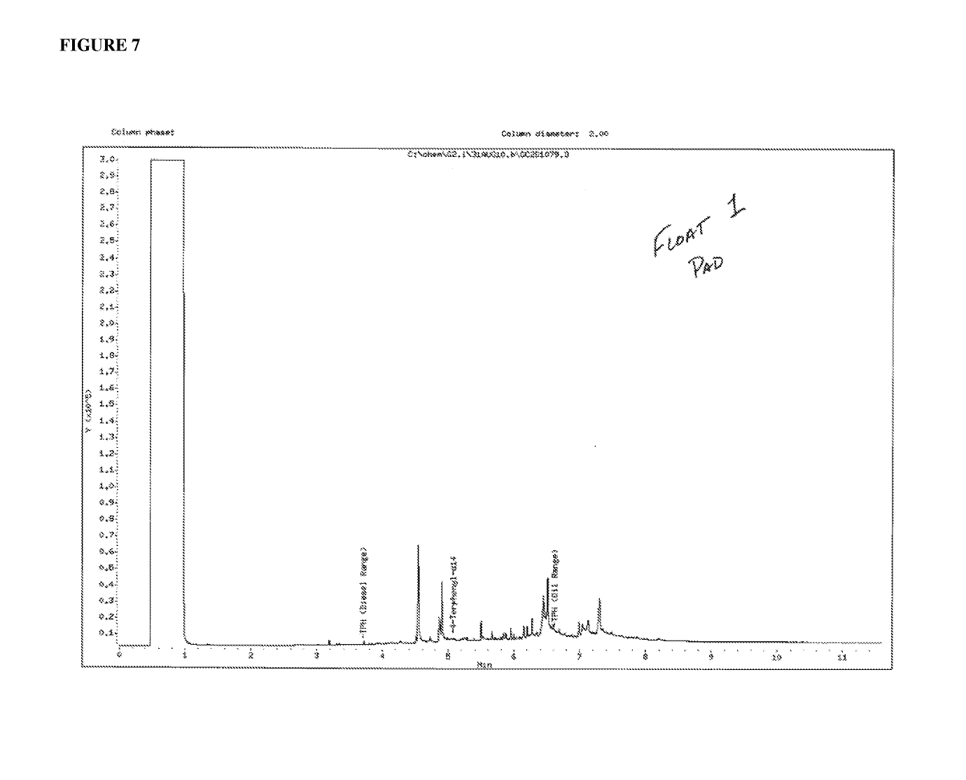

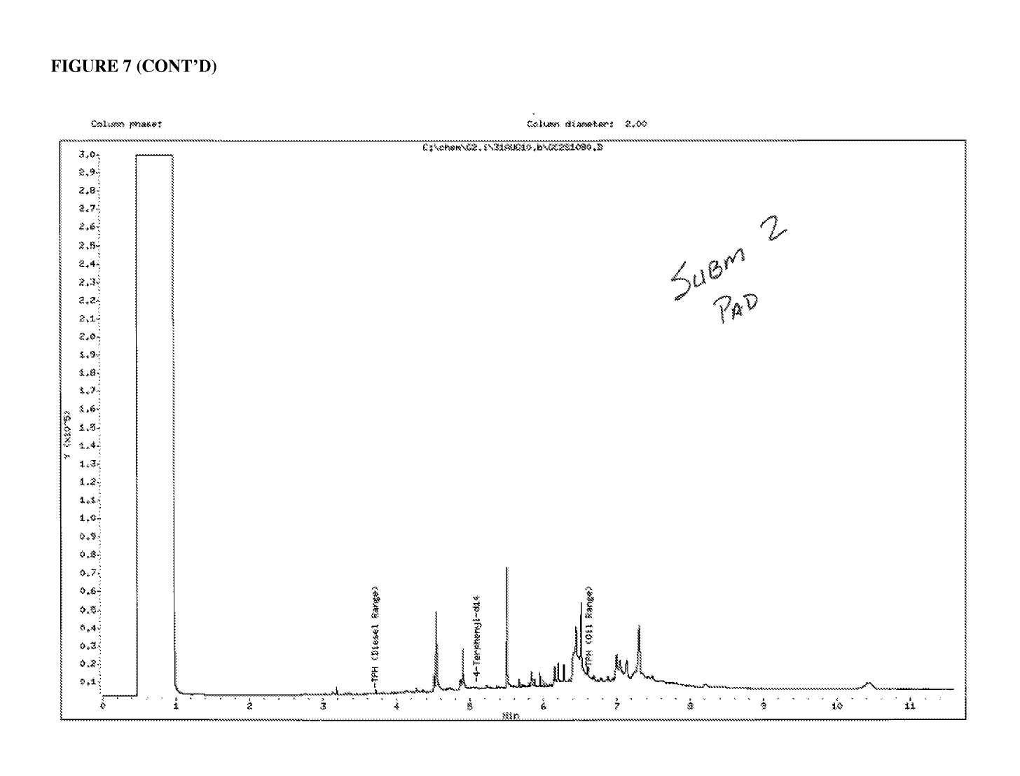

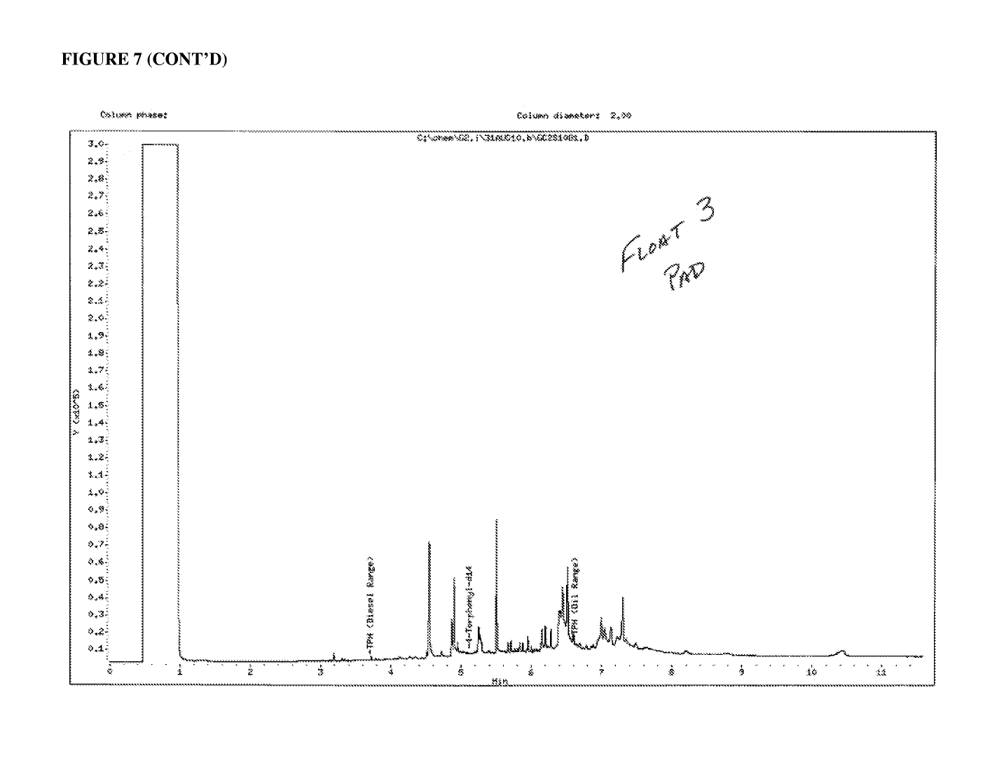

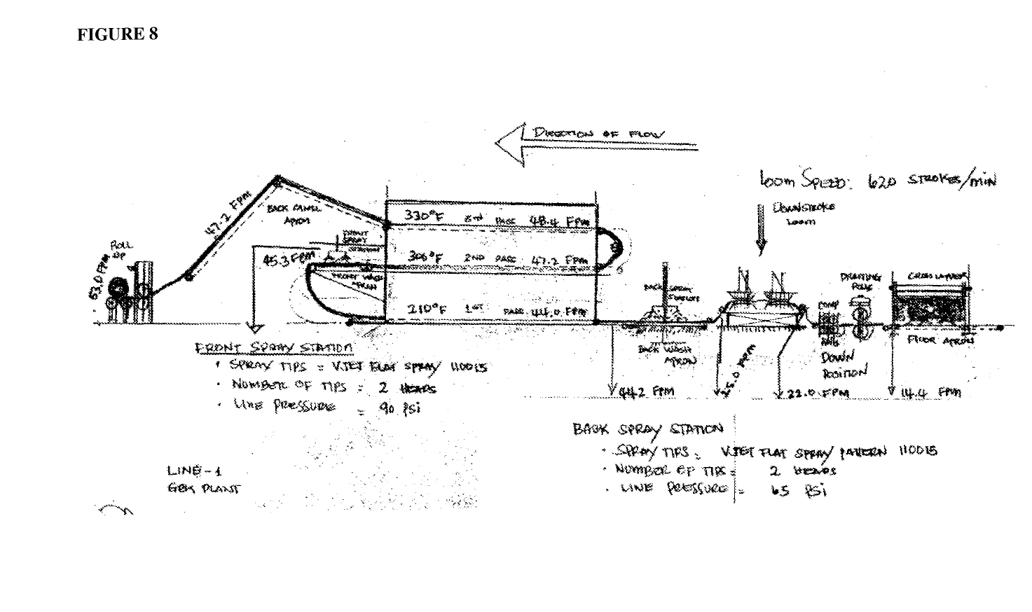

The compounds identified by GCMS in the water samples derived from Submerged Trial #1 are listed in Table 2; (original data and chromatograms may be found in FIGS. 5 and 7, respectively). Their abundances, ranked by concentration, are shown in FIG. 1. The compounds fell into the categories of petroleum hydrocarbons, alcohols, some of which are known to be toxic components of dispersants used in the BP-Deep Horizon spill, and other miscellaneous compounds, including caffeine.

Extraction of the material itself produced only four identifiable compounds, and in small amounts. None of these compounds appeared in the water samples derived from the material. 16 additional compounds were also extracted from the material, but were unidentifiable, based upon the reference library of the laboratory used.

Original reports and charts received from the processing laboratory are shown in FIGS. 4-6. Original chromatograms comparing compounds isolated from the aqueous samples of the submerged 1-1 experiment, with library reference data for known compounds were also obtained, with the details of match probability identified. Data not shown.

The concentrations of these compounds in the water sampled were calculated by estimating volume of water impinging on the material surface over the sampling time. The following variables were used for calculation:

| Material width: | 0.91 | m |
|---|---|---|
| Material length: | 4.54 | m |
| Surface area of material | 4.12 | m² |
| Depth of water presumed interacting with | 3 | mm |
| material | | |
| Boat speed | 0.6 knot = 30.86 cm sec⁻¹ | |
| Tow time | 30 mins = 1.8 × 10³ secs | |
| Est. volume of water interacting with | 7,004 | litres |
| material | | |

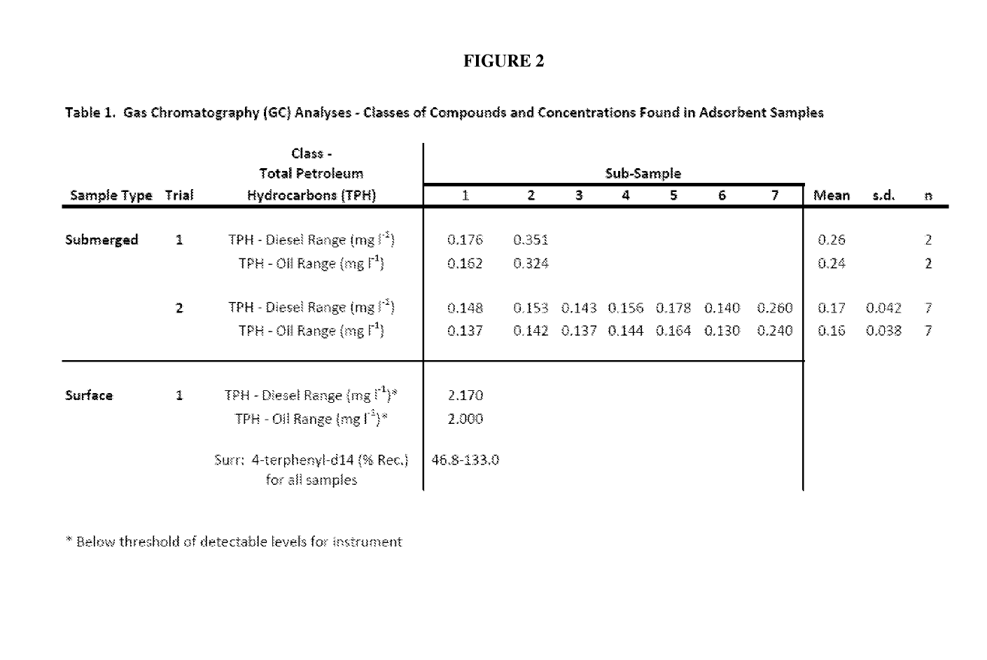

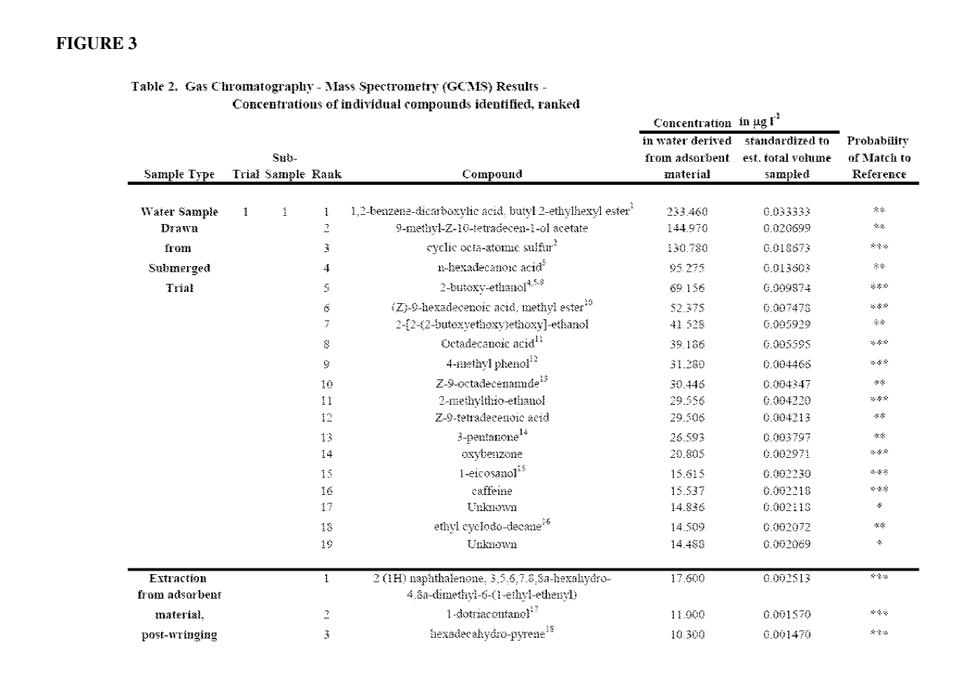

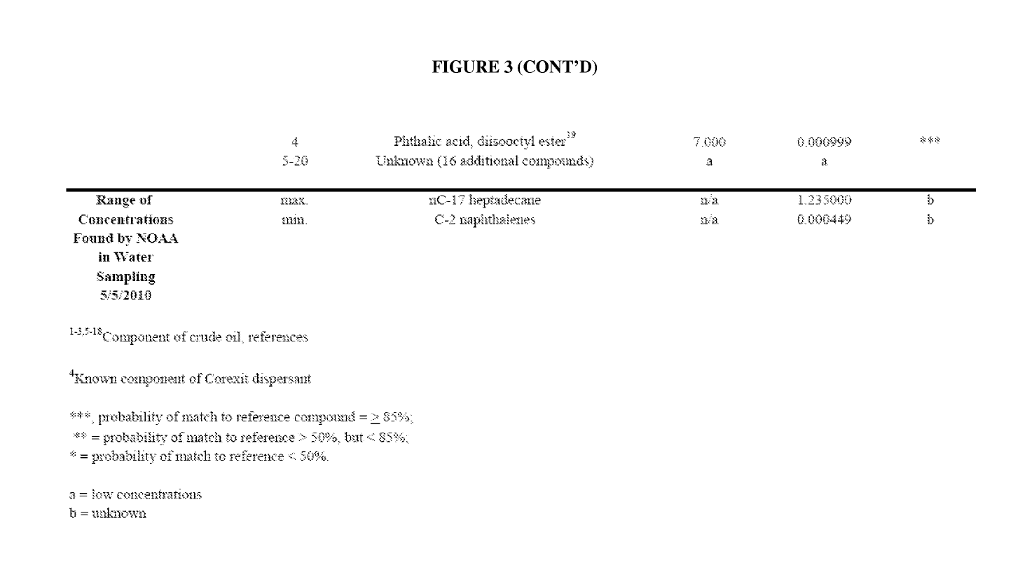

The concentrations of compounds collected by the material are presented in Tables 1 (See FIG. 2) and 2 (See FIG. 3).

We claim:

1. An organic compound adsorbing material comprising a fiber and a metal oxide, wherein the material is arranged as a matrix.

2. The material of claim 1, wherein the fiber is selected from the group consisting of polyester, nylon, cotton, and combinations thereof.

3. The material of claim 1, wherein the fiber is a form selected from the group consisting of knitted fiber, woven fiber and spun-bonded fiber.

4. The material of claim 1, wherein the matrix is selected from the group consisting of a loose packed textile, a woven textile, a nonwoven textile, and a needle punched textile.

5. The material of claim 4, wherein the nonwoven textile is felted.

6. The material of claim 4, wherein the needle punched textile is a nonwoven textile.

7. The material of claim 1, wherein the fiber is a blend of two or more of the fibers.

8. The material of claim 2, wherein the cotton is cotton grown in Georgia, United States of America.

9. The material of claim 2, wherein the cotton is natural cotton.

10. The material of claim 9, wherein the cotton is bleached cotton.

11. The material of claim 7, wherein the blend is a blend of natural cotton and bleached cotton.

12. The material of claim 1, wherein the metal oxide is selected from the group consisting of alumina, silicon dioxide, carbon, titanium, zirconium, copper (I), copper (II), sodium, magnesium, lithium, silver, iron (II), iron (III), chromium (VI), titanium (IV), zinc, and a combination thereof.

13. The material of claim 12, wherein the alumina has a transformation state selected from the group consisting of gamma, eta, rho, chi, chi-rho, and theta.

14. The material of claim 12, wherein the carbon is activated carbon.

15. The material of claim 1, wherein the material comprises the metal oxide on one or more sides.

16. The material of claim 15, wherein the material comprises the metal oxide on two sides.

17. The material of claim 1, wherein the material is saturated with the metal oxide.

18. A method of making the material of claim 1, comprising:
(a) contacting a fiber with a metal oxide to form a metal oxide fiber;
(b) arranging the metal oxide fiber into a matrix; and
(c) drying the metal oxide fiber matrix to form the organic compound adsorbing material of claim 1.

19. The method of claim 18, wherein step (a) is performed via spray coating the metal oxide onto the fiber.

20. The method of claim 18, wherein the metal oxide fiber matrix is dried by a method selected from the group consisting of fluid bed drying, air drying, single pass oven drying, double pass oven drying, and three pass oven drying.

21. The method of claim 18, wherein the metal oxide fiber matrix is acid treated before drying.

22. The method of claim 18, wherein the fiber is selected from the group consisting of polyester, nylon, cotton, and combinations thereof.

23. The method of claim 18, wherein the fiber is selected from the knitted fiber, woven fiber and spun-bonded fiber.

24. The method of claim 18, wherein the matrix is selected from the group consisting of a loose packed textile, a woven textile, a nonwoven textile, and a needle punched textile.

25. The method of claim 24, wherein the nonwoven textile is felted.

26. The method of claim 24, wherein the needle punched textile is a nonwoven textile.

27. The method of claim 22, wherein the fiber is a blend of one or more of the fibers.

28. The method of claim 22, wherein the cotton is cotton grown in Georgia, United States of America.

29. The method of claim 22, wherein the cotton is natural cotton.

30. The method of claim 29, wherein the cotton is bleached cotton.

31. The method of claim 27, wherein the blend is a blend of natural cotton and bleached cotton.

32. The method of claim 18, wherein the metal oxide is selected from the group consisting of alumina, silicon dioxide, carbon, titanium, zirconium, copper (I), copper (II), sodium, magnesium, lithium, silver, iron (II), iron (III), chromium (VI), titanium (IV), zinc, and a combination thereof.

33. The method of claim 32, wherein the alumina has a transformation state selected from the group consisting of gamma, eta, rho, chi, chi-rho, and theta.

34. The method of claim 32, wherein the carbon is activated carbon.

35. A method of making the material of claim 1, comprising:
(a) contacting a matrix of fiber with a metal oxide to form a metal oxide fiber matrix; and
(b) drying the metal oxide fiber matrix to form the organic compound adsorbing material of claim 1.

36. The method of claim 35, wherein step (a) is performed via spray coating the metal oxide onto the matrix of fiber.

37. The method of claim 35, wherein the metal oxide fiber matrix is dried by a method selected from the group consisting of fluid bed drying, air drying, single pass oven drying, double pass oven drying, and three pass oven drying.

38. The method of claim 35, wherein the metal oxide fiber matrix is acid treated before drying.

39. The method of claim 35, wherein the fiber is selected from the group consisting of polyester, nylon, cotton, and combinations thereof.

40. The method of claim 35, wherein the fiber is selected from the knitted fiber, woven fiber and spun-bonded fiber.

41. The method of claim 35, wherein the matrix is selected from the group consisting of a loose packed textile, a woven textile, a nonwoven textile, and a needle punched textile.

42. The method of claim 41, wherein the nonwoven textile is felted.

43. The method of claim 41, wherein the needle punched textile is a nonwoven textile.

44. The method of claim 39, wherein the matrix is a blend of one or more of the fibers.

45. The method of claim 39, wherein the cotton is cotton grown in Georgia, United States of America.

46. The method of claim 39, wherein the cotton is natural cotton.

47. The method of claim 46, wherein the cotton is bleached cotton.

48. The method of claim 44, wherein the blend is a blend of natural cotton and bleached cotton.

49. The method of claim 35, wherein the metal oxide is selected from the group consisting of alumina, silicon dioxide, carbon, titanium, zirconium, copper (I), copper (II), sodium, magnesium, lithium, silver, iron (II), iron (III), chromium (VI), titanium (IV), zinc, and a combination thereof.

50. The method of claim 49, wherein the alumina has a transformation state selected from the group consisting of gamma, eta, rho, chi, chi-rho, and theta.

51. The method of claim 49, wherein the carbon is activated carbon.

52. A method of recovering oil from water comprising:
(a) contacting oily water with the material of claim 1;
(b) maintaining the contact for a time sufficient to allow the material to adsorb a quantity of oil;
(c) separating the material from the water; and
(d) wringing the adsorbed oil from the material.

53. The method of claim 52, wherein the act of contacting the oily water with the material of claim 1 comprises submerging the material into the oily water.

54. The method of claim 52, wherein the act of contacting the oily water with the material of claim 1 comprises floating the material on the oily water.

55. The method of claim 52, wherein the act of wringing comprises conveying the material through rollers.

56. The method of claim 52, wherein the act of contacting the oily water with the material of claim 1 comprises dropping the material into the oily water from a vessel.

57. The method of claim 53, wherein the material is weighted.
